(19) United States
(12) Patent Application Publication
(10) Pub. No.: US 2015/0046808 A1
(43) Pub. Date: Feb. 12, 2015

(54) APPARATUS AND METHOD FOR MULTILAYERED MUSIC PLAYBACK

(71) Applicant: Beamz Interactive, Inc., Scottsdale, AZ (US)

(72) Inventors: Bardia Dejban, Calabasas, CA (US); Shannon Dejban, Calabasas, CA (US); Gary Bencar, Holualoa, HI (US); Dave Sandler, Saint James, NY (US); Charles Mollo, Scottsdale, AZ (US)

(73) Assignee: Beamz Interactive, Inc., Scottsdale, AZ (US)

(21) Appl. No.: 14/088,178

(22) Filed: Nov. 22, 2013

Related U.S. Application Data
(60) Provisional application No. 61/863,824, filed on Aug. 8, 2013.

(51) Int. Cl. G06F 3/0484; G06F 3/16; G06F 3/0488

(52) U.S. Cl. CPC G06F 3/0484; G06F 3/0488; G06F 3/162
USPC 715/716

(57) ABSTRACT

Method and apparatus of a touchscreen device for playback of a multilayered media file are provided. The method includes displaying a plurality of triggers, each of the triggers is associated with a distinct layer of a plurality of layers of the multilayered media file. The method further includes receiving a touch gesture related to a touch on the touchscreen. The method further includes controlling playback of one or more layers of a plurality of layers of media associated with the multilayered media file based on the touch gesture.

### CROSS-REFERENCE TO RELATED APPLICATION(S) AND CLAIM OF PRIORITY

The present application claims priority to U.S. Provisional Patent Application Ser. No. 61/863,824, filed Aug. 8, 2013, entitled “APPARATUS AND METHOD FOR LAYERED MUSIC PLAYBACK”; the content of the above-identified patent document is incorporated herein by reference.

### TECHNICAL FIELD

The present application relates generally to playing media, more specifically, to multilayered media.

### BACKGROUND

Touchscreen devices, such as tablets, smartphones, portable music players, laptop computers, and desktop computers allow for interaction with applications of the touchscreen devices by touching the device instead of or in addition to other forms input. The market for touchscreen devices has expanded greatly due to the ease of use and control provided by touchscreen devices.

Applications of touchscreen devices allow for the playback of media via the touchscreen device. The ease-of-use and control provided by the touchscreen devices enhances the interactivity of the applications for playback of media. As the complexity of the applications increase, there is a need for more advanced touchscreen interfaces and engines, particularly in the area of multilayered media including musical and audio applications.

### SUMMARY

Method and apparatus of a touchscreen device for playback of a multilayered media file are provided. The method includes displaying a plurality of triggers, each of the triggers is associated with a distinct layer of a plurality of layers of the multilayered media file. The method further includes receiving a touch gesture related to a touch on the touchscreen. The method further includes controlling playback of one or more layers of a plurality of layers of media associated with the multilayered media file based on the touch gesture.

An apparatus configured for playback of a multilayered media file is provided. The apparatus comprises a touchscreen configured to receive a touch on the touchscreen. The apparatus further comprises one or more processors configured to cause a display of the apparatus to display a plurality of triggers, each of the triggers is associated with a distinct layer of a plurality of layers of the multilayered media file. The one or more processors are further configured to receive a touch gesture related to the touch on the touchscreen. The one or more processors are further configured to control playback of one or more layers of a plurality of layers of media associated with the multilayered media file based on the touch gesture.

A computer readable medium configured to store program instructions for playback of a multilayered media file is provided. The program instructions are configured to cause one or more processors to cause a display to display of a plurality of triggers, each of the triggers associated with a distinct layer of a plurality of layers of the multilayered media file. The program instructions are further configured to cause one or more processors to receive a touch gesture related to a touch on a touchscreen. The program instructions are further configured to cause one or more processors to control playback of one or more layers of a plurality of layers of media associated with the multilayered media file based on the touch gesture.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example electronic device according to embodiments of the present disclosure;

FIG. 2 illustrates a diagram of a system for layered music playback in accordance with embodiments of the present disclosure;

FIG. 3 illustrates a graphical user interface (GUI) in accordance with embodiments of the present disclosure;

FIG. 4 illustrates the graphical user interface (GUI) of FIG. 3 with a different beam layout and instruments in accordance with embodiments of the present disclosure; and

FIG. 5 illustrates a flowchart for playback of a multilayered media file according to embodiments of the present disclosure.

### DETAILED DESCRIPTION

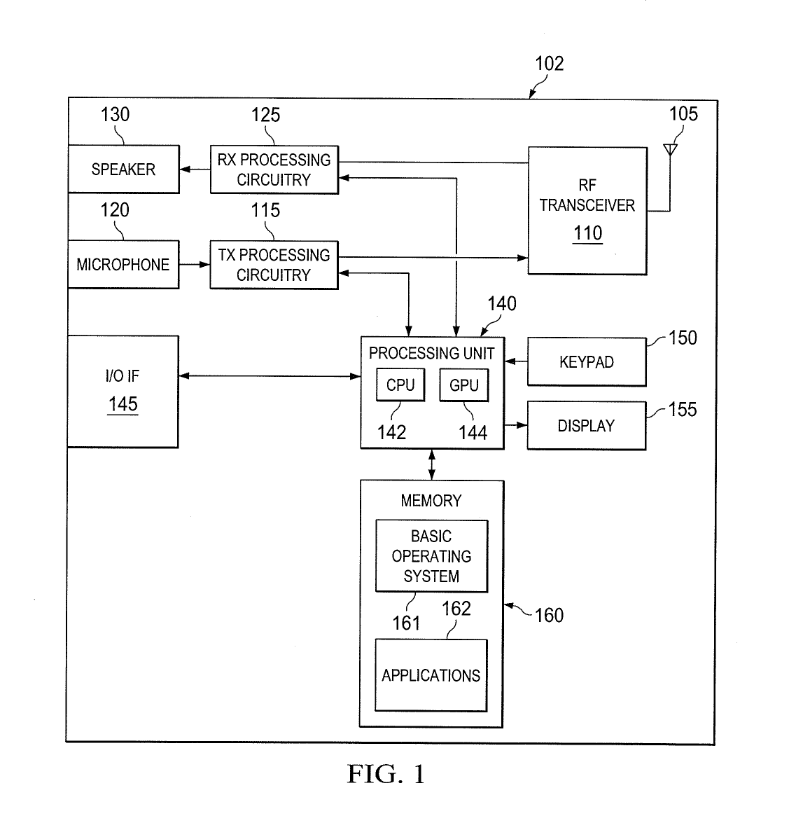

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

FIG. 1 illustrates an example electronic device 102 according to embodiments of the present disclosure. The embodiment of the electronic device 102 shown in FIG. 1 is for illustration only. Other embodiments of an electronic device could be used without departing from the scope of this disclosure.

The electronic device 102 includes an antenna 105, a radio frequency (RF) transceiver 110, transmit (TX) processing circuitry 115, a microphone 120, and receive (RX) processing circuitry 125. The electronic device 102 also includes a speaker 130, a processing unit 140, an input/output (I/O) interface (IF) 145, a keypad 150, a display 155, and a memory 160. The electronic device 102 could include any number of each of these components.

The processing unit 140 includes processing circuitry configured to execute instructions, such as instructions stored in the memory 160 or internally within the processing unit 140. The memory 160 includes a basic operating system (OS) program 161 and one or more applications 162. The electronic device 102 could represent any suitable device. In particular embodiments, the electronic device 102 represents a mobile telephone, smartphone, personal digital assistant, tablet computer, a touchscreen computer, and the like. The electronic device 102 plays multilayered media.

The RF transceiver 110 receives, from the antenna 105, an incoming RF signal transmitted by a base station or other device in a wireless network. The RF transceiver 110 down-converts the incoming RF signal to produce an intermediate frequency (IF) or baseband signal. The IF or baseband signal is sent to the RX processing circuitry 125, which produces a processed baseband signal (such as by filtering, decoding, and/or digitizing the baseband or IF signal). The RX processing circuitry 125 can provide the processed baseband signal to the speaker 130 (for voice data) or to the processing unit 140 for further processing (such as for web browsing or other data). The RF transceiver could also be an infrared (IR) transceiver, and limitation to the type of transceiver is not to be inferred.

The TX processing circuitry 115 receives analog or digital voice data from the microphone 120 or other outgoing baseband data (such as web data, e-mail, or interactive video game data) from the processing unit 140. The TX processing circuitry 115 encodes, multiplexes, and/or digitizes the outgoing baseband data to produce a processed baseband or IF signal. The RF transceiver 110 receives the outgoing processed baseband or IF signal from the TX processing circuitry 115 and up-converts the baseband or IF signal to an RF signal that is transmitted via the antenna 105.

In some embodiments, the processing unit 140 includes one or more processors, such as central processing unit (CPU) 142 and graphics processing unit (GPU) 144, embodied in one or more discrete devices. In some embodiments, the CPU 142 and the GPU 144 are implemented as one or more integrated circuits disposed on one or more printed circuit boards. The memory 160 is coupled to the processing unit 140. In some embodiments, part of the memory 160 represents a random access memory (RAM), and another part of the memory 160 represents a Flash memory acting as a read-only memory (ROM).

In some embodiments, the memory 160 is a computer readable medium that stores program instructions to play multilayered media. When the program instructions are executed by the processing unit 140, the program instructions cause one or more of the processing unit 140, CPU 142, and GPU 144 to execute various functions and programs in accordance with embodiments of this disclosure.

The processing unit 140 executes the basic OS program 161 stored in the memory 160 in order to control the overall operation of electronic device 102. For example, the processing unit 140 can control the RF transceiver 110, RX processing circuitry 125, and TX processing circuitry 115 in accordance with well-known principles to control the reception of forward channel signals and the transmission of reverse channel signals.

The processing unit 140 is also capable of executing other processes and programs resident in the memory 160, such as operations for playing multilayered media as described in more detail below. The processing unit 140 can also move data into or out of the memory 160 as required by an executing process. In some embodiments, the processing unit 140 is configured to execute a plurality of applications 162. The processing unit 140 can operate the applications 162 based on the OS program 161 or in response to a signal received from a base station. The processing unit 140 is coupled to the I/O interface 145, which provides electronic device 102 with the ability to connect to other devices, such as laptop computers, handheld computers, and server computers. The I/O interface 145 is the communication path between these accessories and the processing unit 140.

The processing unit 140 is also optionally coupled to the keypad 150 and the display unit 155. An operator of electronic device 102 uses the keypad 150 to enter data into electronic device 102. The display 155 may be a liquid crystal display, light emitting diode (LED) display, or other display capable of rendering text and/or at least limited graphics from web sites. Display unit 155 may be a touchscreen which displays keypad 150. Alternate embodiments may use other types of input/output devices and displays.

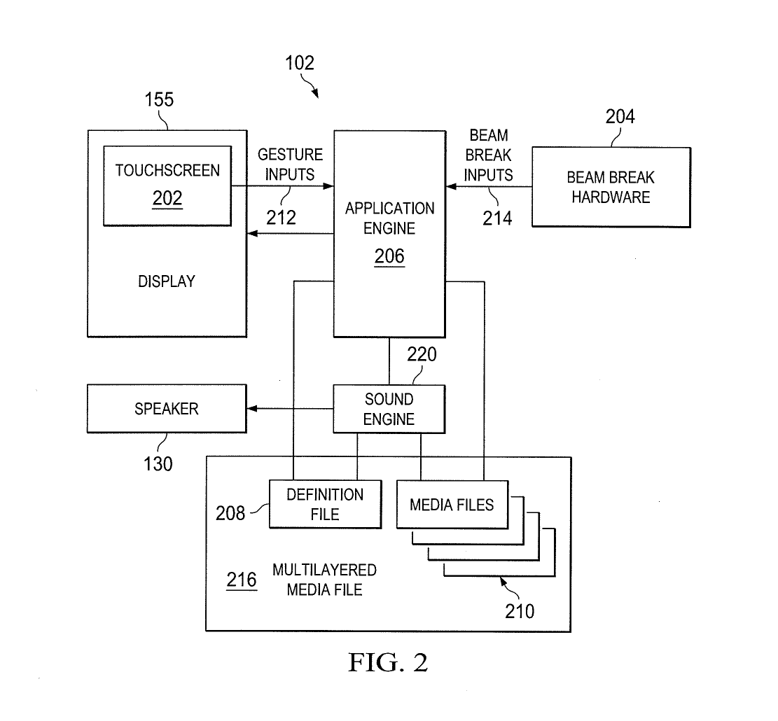

FIG. 2 illustrates a diagram of a system for layered music playback in accordance with embodiments of the present disclosure. The system of FIG. 2 can be implemented in electronic device 102 and embodied as one of a computer, a smart phone, a tablet, a touchscreen computer, and the like. Application engine 206 receives one or more of gesture inputs 212 from touchscreen 202 of display unit 155, and may also receive beam break inputs 214 from beam break hardware 204. Application engine 206 controls playback of media files 210 that are combined to form multilayered media file 216 based on one or more of gesture inputs 212, beam break inputs 214, and definition file 208 via sound engine 220.

Gesture inputs 212 include one or more touch gestures that indicate when and how touchscreen 202 is being touched. Gesture inputs 212 include a tap gesture, a long press gesture, and a drag gesture. With a tap gesture or a long press gesture, a touch starts and ends at substantially the same point on touchscreen 202 on display 155 of electronic device 102. With a tap gesture, the touch is held at substantially the same point on touch screen x302 on display 155 for a substantially short period of time, such as with a threshold for the short period of time of 0.5 seconds or less. With a long press gesture, the touch is held at substantially the same point on touch screen x302 on display 155 for a longer period of time, such as with a threshold for the longer period of time of 0.5 seconds or more. Additional thresholds may be used for a long press gesture with each threshold associated with a different action to be taken by the application 162. With a drag gesture, the touch is at least partially moved while it is being held on touchscreen 202 of display 155 of electronic device 202 and is held until the touch is released.

Output from application engine 206 is displayed on the display 155 and output from sound engine 220 is played on speaker 130. The combination of application engine 206 and 220 form an application, such as application 162. Display 155 comprises touchscreen 202. When displayed, output from application engine 206 can be shown to simulate beam break hardware 204 on display 155.

Multilayered media file 216 comprises a plurality of music programs, such as media files 210 that each comprise one or more audio files and video files. Multilayered media file 216 includes definition file 208. Each of the music programs comprises a subset of a predetermined musical composition, shown in FIG. 2 as media files 210, which are also referred to as a layer of media. Each of the music programs or layers of media is correlated to each other and comprises sound elements configured to generate sympathetic musical sounds. A trigger can be associated with a musical program to control the timing and playback of the musical program. When multiple media files are played together, an entire song or composition that incorporates each of the layers of media files 210 can be heard and seen via display 155 and speaker 130. Application engine 206 and sound engine 220 control which media files 210 of multilayered media file 216 are played and when media files 210 are played based on gesture inputs 212, beam break inputs 204, and definition file 208. Certain media files 210 can lasts an entire length of the song, whereas other media files 210 may last for a shorter duration, and can be referred to as a one-shot. Multilayered media file 216 can be an archive file comprising additional files. In certain embodiments, multilayered media file 216 is derived from a single MP3 or WAV file.

Definition file 208 describes media files 210 and one or more beam layouts for application engine 206 and sound engine 220. Based on the information of definition file 18, application engine 206 and sound engine 220 determine specific timings for when media files 210 are played based on one or more of gesture inputs 212 and beam break inputs 214.

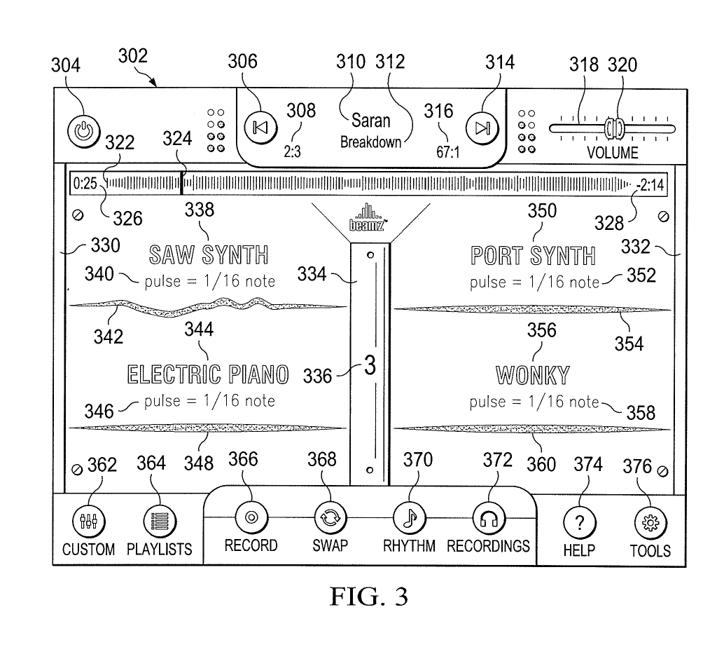

FIG. 3 illustrates a graphical user interface (GUI) in accordance with embodiments of the present disclosure. The embodiment shown in FIG. 3 is for illustration only. Other embodiments could be used without departing from the scope of this disclosure.

GUI 302 includes several user interface (UI) elements to manipulate multilayered media playback. GUI 302 is displayed on touchscreen 202 to allow a user to interact with the UI elements of GUI 302.

Power button 304 toggles between an on state and an off state. In the on state, the application 162 consumes sufficient resources to allow for playback of the multilayered media. In the on state, sound engine 220 is loaded and the media files 210 for the multilayered media are also loaded, which allows for playback of the multilayered media. In the off state, application 162 consumes fewer system resources and does not allow for playback of the multilayered media. In the off state, sound engine 220 is not loaded and media files 210 for multilayered media are also not loaded, so as to reduce consumption of resources when multilayered media is not being played. In the off state, other features of application 162 are still usable, but playback of the multilayered media is not provided for.

A threshold can be used with power button 304 to prevent unintended toggling between the on state and the off state. The threshold requires a certain amount of time, such as five seconds, to elapse while power button 304 is pressed before toggling between the on state and the off state. This prevents inadvertent touches of power button 304 from ending playback by toggling from the on state to the off state.

Buttons 306 and 314 provide for switching between different multilayered media files. Interaction with button 306 causes the application 162 to switch to a previous multilayered media file in a playlist. Interaction with button 314 causes the application 162 to switch to a subsequent multilayered media file in a playlist.

Text elements 308 and 316 provide information about previous and subsequent multilayered media files. Text element 308 indicates the previous multilayered media file includes an attribute of “2:3.” Text element 316 indicates the subsequent multilayered media file includes an attribute of “67:1.”

Text elements 310 and 312 provide information about current multilayered media file 216. Text element 310 indicates a song name of multilayered media file 216 is “Saran.” Text element 312 indicates a name of a current playlist of multilayered media file 216 is “Breakdown.”

Track 318 and slider 320 operate to provide a volume slider to control volume of the application 162 of the multilayered media playback. Track 318 provides a graphical indication of available volume settings via a length of track 318. Slider 320 provides a graphical indication of a current volume setting via a position of slider 320 respect to track 318. In certain embodiments, multiple tracks and sliders are provided so that each layer of multilayered media can have its own volume control.

In certain embodiments, track 318 and slider 320 are used to control volume of one or more individual layers of multilayered media. To control multiple layers with slider 320, one or more beams, such as beams 354 and 360, are pressed and slider 320 is manipulated while beams 354 and 360 are pressed to control the volume of the layers of media associated with beams 354 and 360.

Window 322 provides an indication of amplitude of one or more layers of multilayered media of multilayered media file 216. Element 324 scrolls across window 322 and provides an indication of a current position of multilayered media playback. Display of window 322 can be zoomed or scrolled using one or more touch actions or gestures to display amplitudes over certain portions of time of the multilayered media.

In certain embodiments the amplitude indicated on window 322 is static. When the amplitude is static, window 322 displays an amplitude of the multilayered media, such as an amplitude of a base rhythm layer or an amplitude of a sum of all the layers of the multilayered media.

In certain embodiments, the amplitude indicated on window 322 is dynamic. When the amplitude is dynamic, window 322 displays the amplitude of a sum of the base rhythm layer and any other active layers of the multilayered media that were active the last time the multilayered media was played back or the last time element 324 scrolled over a position of window 322. When one or more of beams 342, 348, 354, 360 are triggered, an amplitude of a layer of media associated with the respective one or more beams 342, 348, 354, and 360 is used to create the amplitude indicated on window 322 shown via GUI 302 on device 102.

In certain embodiments, element 324 changes color based on triggering of one or more beams. Element 324 can also include multiple colors to indicate beam triggering. Although not shown, element 324 can include a first portion, a second portion, a third portion, and a fourth portion, that are associated respectively with beams 342, 348, 354, and 360. One or more of the first through fourth portions of element 324 change color based on a triggering of one or more respective beams 342, 348, 354, and 360.

Elements 326 and 328 indicate a time related to playback of multilayered media that is loaded by application 162 on device 102. Element 326 indicates how much time has elapsed from a beginning of a multilayered media and element 328 indicates how much time is remaining in playback of the multilayered media, both of which are also indicated via a position of element 324 with respect to window 322.

In certain embodiments, elements 326 and 328 indicate a start time and a stop time of a portion of an amplitude of multilayered media that is displayed within window 322. Although not shown, element 326 can indicate a start time of the portion of the amplitude of the multilayered media displayed in window 322 and element 328 can indicate a stop time of the portion of the amplitude of the multilayered media displayed in window 322, such as when the display of window 322 is zoomed in and does not show an amplitude signal for an entire length of multilayered media file 216.

GUI 302 includes optional elements 330, 332, and 334, which indicate boundaries for beams 342, 348, 354, and 360 of the four instruments displayed. Element 334 includes element 336, which provides an indication of which beam layout is currently displayed for use on GUI 302. Multilayered media file 216 includes one or more beam layouts. A beam layout defines how many beams are displayed, the position of each beam, the association of each beam to a layer of media, how interaction with a beam controls the associated layer of media. GUI 302 shows a third beam layout, as indicated by the number “3” on element 336, that includes four beams 342, 348, 354, and 360 of four instruments.

Display of beam 342 on GUI 302 includes text elements 338 and 340. Text element 338 indicates a name of the instrument and layer of media associated with beam 342. Text element 340 indicates additional information about the instrument and layer of media associated with beam 342. As illustrated by text elements 338 and 340, the layer of media associated with beam 342 is an instrument named “saw synth” with a pulse of one sixteenth note. Text of text elements 338 and 340 and which type of attribute is shown in text element 340 can be defined in a beam layout of multilayered media file 216, such as in definition file 208. Beam 342 on GUI 302 is active, as indicated by the display of beam 342 as compared to beams 348, 354, and 360, which are not active.

Display of beam 348 on GUI 302 includes text elements 344 and 346. Text element 344 indicates a name of the instrument and a layer of media associated with beam 348. Text element 346 indicates additional information about the instrument and layer of media associated with beam 348. As illustrated by text elements 344 and 346, the layer of media associated with beam 348 is an instrument named “electric piano” with a pulse of one sixteenth note. Text of text elements 344 and 346 and which type of attribute is shown in text element 346 can be defined in a beam layout of multilayered media file 216, such as in definition file 208.

Display of beam 354 on GUI 302 includes text elements 350 and 352. Text element 350 indicates a name of the instrument and layer of media associated with beam 354. Text element 352 indicates additional information about the instrument and layer of media associated with beam 354. As illustrated by text elements 350 and 352, the layer of media associated with beam 354 is an instrument named “port synth” with a pulse of one sixteenth note. Text of text elements 350 and 352 and which type of attribute is shown in text element 352 can be defined in a beam layout of multilayered media file 216, such as in definition file 208.

Display of beam 360 on GUI 302 includes text elements 356 and 358. Text element 356 indicates a name of the instrument and layer of media associated with beam 360. Text element 358 indicates additional information about the instrument and layer of media associated with beam 360. As illustrated by text elements 356 and 358, the layer of media associated with beam 360 is an instrument named “wonky” with a pulse of one sixteenth note. Text of text elements 356 and 358 and which type of attribute is shown in text element 358 can be defined in a beam layout of multilayered media file 216, such as in definition file 208.

Interaction with beam 342, and similarly for beams 348, 354, and 360, is accomplished via one or more touch gestures in relation to a respective beam. Beam 342 is triggered with one or more of a tap gesture, a long press gesture, or a drag gesture wherein coordinates of the one or more touch gestures correspond to a location of beam 342 on GUI 302 on display 102. With a tap gesture or a long press gesture, a touch starts and ends in substantially the same at substantially the same point on GUI 302 on display 102.

A drag gesture can cross one or more of beams 342, 344, 354, and 360. When more than one of beams 342, 344, 354, and 360 are crossed within a given time threshold, such as 0.5 seconds, each of the beams that are crossed are treated as being crossed at the same time so that each layer of media associated with a crossed beams is played back in a similar fashion, such as at the same time, even though each of the individual beams are crossed at different times.

In certain embodiments, a location of a touch as indicated by a touch gesture can provide additional control of certain attributes or properties of the layer of media associated with a beam, such as beam 342 with the additional control being stored in the beam layout and being reconfigurable. The touch gesture can be one or more of a tap gesture, a long press gesture, or a drag gesture. Position of a touch indicated by a touch gesture along beam 342 and a distance of that touch to either element 330 or element 336 allows for control of one or more of phase, frequency, amplitude, volume, pitch, tone, speed, offset, and the like, of the layer of media associated with beam 342. A touch indicated by a touch gesture along beam 342 that is closer to element 330 triggers the layer of media associated with beam 342 and plays the layer of media with one or more of a lower phase, a lower frequency, a lower amplitude, a lower volume, a lower pitch, a lower tone, and a slower speed as compared to a touch along beam 342 that is closer to element 336. A touch along beam 342 that is closer to element 336 triggers the layer of media associated with beam 342 and plays the layer of media with one or more of a higher phase, a higher frequency, a higher amplitude, a higher volume, a higher pitch, a higher tone, and a faster speed as compared to a touch along beam 342 that is closer to element 330. When the touch is indicated by a drag gesture, the attribute of the beam being controlled can be continuously updated based on the change of the position or movement of the touch as indicated by the drag gesture.

Additionally, movement of the touch indicated by the drag gesture in orthogonal directions can control different attributes. Horizontal movements can control a first set of one or more attributes that include phase, frequency, amplitude, volume, pitch, tone, speed, offset, and the like, of the layer of media associated with a beam. Vertical movements can control a second set of the one or more attributes that include of phase, frequency, amplitude, volume, pitch, tone, speed, offset, and the like, of the layer of media associated with a beam. For example, horizontal movements can control a speed of the layer of media associated with a beam and vertical movements can control a pitch of the layer of media associated with the beam.

Attributes of the first set of the one or more attributes can be different from attributes of the second set of the one or more attributes. In certain embodiments, attributes of the first set of the one or more attributes can include one or more of the attributes of the second set of the one or more attributes.

As illustrated in FIG. 3, display of beam 342 indicates beam 342 is active and displays of beams 344, 354, and 360 indicate beams 344, 354, and 360 are not active. A shape of beam 342 differs from the shapes of beams 344, 354, and 360 to indicate that beam 342 is active and beams 344, 354, and 360 are not active. Other properties or attributes of the display of beam 342 can be changed to indicate that beam 342 is active, such as, size, color, and the like.

When interacted with, button 362 allows for customization of beam layouts and instruments displayed on GUI 302, which can be stored in a definition file, such as definition file 208. When button 362 is interacted with via a tap gesture, processing unit 140 causes display 155 to toggle display of a menu for customizing beam layouts and instruments.

When interacted with, button 364 allows for customization and management of playlists used by application 162. When button 364 is interacted with via a tap gesture, processing unit 140 causes display 155 to toggle display of a menu for customizing and managing playlists.

When interacted with, button 366 allows for recording output of the current session. When button 366 is interacted with via a tap gesture, processing unit 140 causes the combined media that includes all of the active layers of media of multilayered media file 216 being played to be recorded to a memory, such as memory 160 of electronic device 102, so that the recorded combined media can be played back without having to re-create all of the user inputs and touch gestures that created the current playlist session.

When interacted with, button 368 allows for swapping instruments or beam layouts in a current playlist session. When button 368 is interacted with via a tap gesture, processing unit 140 causes a next instrument or beam layout to be loaded and displayed onto display 155. Processing unit 140 also cause display of text element 336 to be updated.

When interacted with, button 370 allows for starting or stopping a rhythm layer of media. When button 370 is interacted with via a tap gesture, processing unit 140 causes the rhythm layer of media of multilayered media file 216 to be output via speaker 130.

When interacted with, button 372 allows for playback of recordings created via button 366. When button 372 is interacted with via a tap gesture, processing unit 140 causes display 155 to toggle display of a menu for playing recordings created via button 366.

When interacted with, button 374 provide a help menu. When button 374 is interacted with via a tap gesture, processing unit 140 causes display 155 to toggle display of a menu to provide help with one or more of using GUI 302, using application 162, and interacting with the UI elements of GUI 302.

When interacted with, button 376 provide a tools menu. When button 376 is interacted with via a tap gesture, processing unit 140 causes display 155 to toggle display of a menu providing various tools and settings to control GUI 302 and application 162.

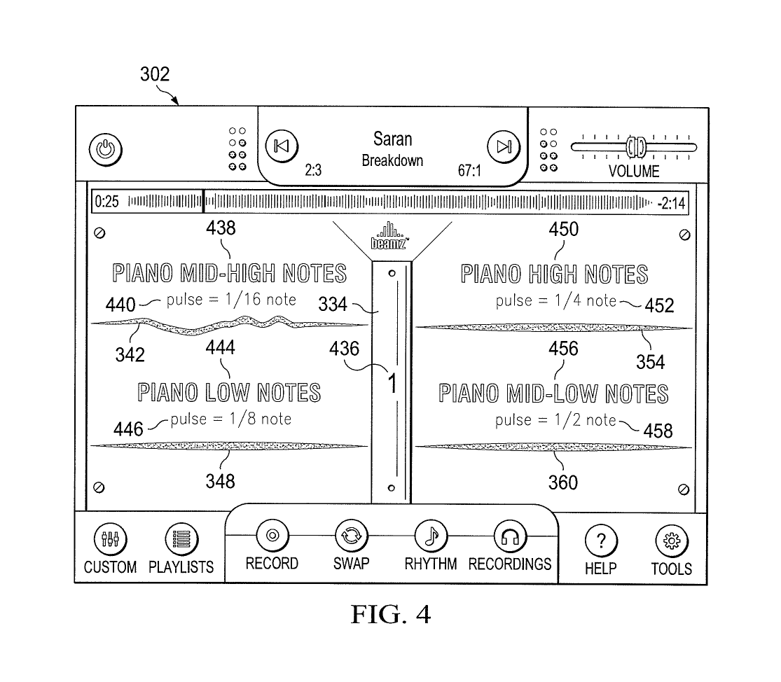

FIG. 4 illustrates the graphical user interface (GUI) of FIG. 3 with a different beam layout and instruments in accordance with embodiments of the present disclosure. The embodiment shown in FIG. 4 is for illustration only. Other embodiments could be used without departing from the scope of this disclosure.

UI elements of GUI 302 are changed between FIGS. 3 and 4 to correspond to different beam layouts and instruments being controlled. The size, shape, and position of beams 342, 348, 354, and 360 are the same where text elements 438, 440, 444, 446, 450, 452, 456, and 458 are changed.

Display of beam 342 on GUI 302 includes text elements 438 and 440. Text element 438 indicates a name of the instrument and layer of media associated with beam 342. Text element 440 indicates additional information about the instrument and layer of media associated with beam 342. As illustrated by text elements 438 and 440, the layer of media associated with beam 342 is an instrument named “piano mid-high notes” with a pulse of one sixteenth note. Text of text elements 438 and 440 and which type of attribute is shown in text element 440 can be defined in a beam layout of multilayered media file 216, such as in definition file 208.

Display of beam 348 on GUI 302 includes text elements 444 and 446. Text element 444 indicates a name of the instrument and a layer of media associated with beam 348. Text element 446 indicates additional information about the instrument and layer of media associated with beam 348. As illustrated by text elements 444 and 446, the layer of media associated with beam 348 is an instrument named “piano low notes” with a pulse of one eighth note. Text of text elements 444 and 446 and which type of attribute is shown in text element 446 can be defined in a beam layout of multilayered media file 216, such as in definition file 208.

Display of beam 354 on GUI 302 includes text elements 450 and 452. Text element 450 indicates a name of the instrument and layer of media associated with beam 354. Text element 452 indicates additional information about the instrument and layer of media associated with beam 354. As illustrated by text elements 450 and 452, the layer of media associated with beam 354 is an instrument named “piano high notes” with a pulse of one quarter note. Text of text elements 450 and 452 and which type of attribute is shown in text element 452 can be defined in a beam layout of multilayered media file 216, such as in definition file 208.

Display of beam 360 on GUI 302 includes text elements 456 and 458. Text element 456 indicates a name of the instrument and layer of media associated with beam 360. Text element 458 indicates additional information about the instrument and layer of media associated with beam 360. As illustrated by text elements 456 and 458, the layer of media associated with beam 360 is an instrument named “piano mid-low notes” with a pulse of one half note. Text of text elements 456 and 458 and which type of attribute is shown in text element 458 can be defined in a beam layout of multilayered media file 216, such as in definition file 208.

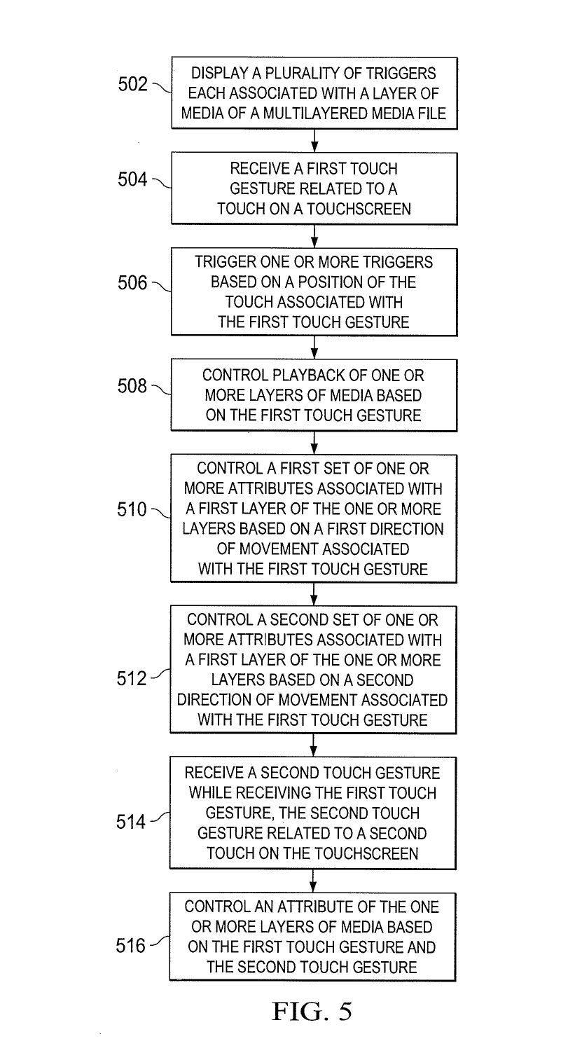

FIG. 5 illustrates a flowchart for playback of multilayered media file 216 according to embodiments of the present disclosure. While the flowchart depicts a series of sequential steps, unless explicitly stated, no inference should be drawn from that sequence regarding specific order of performance of steps, or portions thereof, serially rather than concurrently or in an overlapping manner, or performance the steps depicted exclusively without the occurrence of intervening or intermediate steps. The process depicted in the example is implemented by any suitably configured electronic device, such as electronic device 102 of FIG. 1.

At step 502, display 155 of electronic device 102 displays a plurality of triggers as a plurality of beams, such as beams 342, 348, 354, and 360, that are each associated with a distinct layer of media of multilayered media file 216. Display of beams 342, 348, 354, and 360 is in accordance with one or more beam layouts defined via a portion of multilayered media file 216.

At step 504, processing unit 140 receives a first touch gesture that is related to a touch on touchscreen 202. The touch is by one or more of a thumb, a finger, a stylus, and the like, used to control electronic device 102.

At step 506, processing unit 140 triggers one or more triggers corresponding to beams 342, 348, 354, and 360 based on a position of the touch associated with the first touch gesture. When triggered, an image, size, shape, color, and the like, of a triggered beam changes to indicate the beam that has been triggered. When a beam is not triggered, display of the beam includes a straight line. When a beam is triggered, display of the beam includes a shape that is different from a straight line, and can optionally include a representation of the layer of media associated with the beam.

At step 508, processing unit 140 controls playback of one or more layers of media of multilayered media file 216 based on the first touch gesture. When the first touch gesture is a tap gesture, processing unit 140 causes playback of a predetermined minimum portion or amount of time of the layer of media associated with the beam triggered by the first touch gesture. When the first touch gesture is a long press gesture, processing unit 140 causes playback of the layer of media associated with the beam triggered by the first touch gesture for a duration of the long press gesture. When the first touch gesture is a drag gesture, processing unit 140 causes playback of the layer of media associated with the beam triggered by the first touch gesture for a duration of the drag gesture and optionally controls one or more attributes of the layer of media based on movement of the first touch gesture.

At step 510, processing unit 140 controls a first set of one or more attributes associated with a first layer of media of the one or more layers of media of multilayered media file 216, the control based on a first direction of movement associated with the first touch gesture. The first direction of movement can control one or more of phase, frequency, amplitude, volume, pitch, tone, speed, offset, and the like, of the layer of media.

At step 512, processing unit 140 controls a second set of the one or more attributes associated with the first layer of media of the one or more layers of media of multilayered media file 216, the control based on a second direction of movement associated with the first touch gesture. The second direction of movement can control one or more of phase, frequency, amplitude, volume, pitch, tone, speed, offset, and the like, of the layer of media. The first direction of movement is substantially orthogonal to the second direction of movement and the first direction of movement can be substantially horizontal and the second direction can be substantially vertical.

At step 514, processing unit 140 receives a second touch gesture that is related to a second touch on touchscreen 202. The second touch gesture is received while receiving the first touch gesture. The first touch gesture can be a long press gesture associated with a beam, such as beam 342, and the second touch gesture can be a drag associated with another UI element, such as slider 320. In certain embodiments, multiple beams can be triggered with a plurality of long press gestures and an additional drag gesture can be associated with another UI element, such as slider 320.

At step 516, processing unit 140 controls an attribute of the one or more layers of media of multilayered media file 216 based on the first touch gesture and the second touch gesture. When the first touch gesture is a long press of a beam, such as beam 342, and the second touch gesture is a drag gesture of slider 320, the processing unit 140 controls a volume attribute of a layer of media associated with beam 342. In certain embodiments, when multiple beams are triggered by a plurality of long press gestures and an additional touch gesture is a drag gesture of slider 320, the processing unit 140 controls a volume attribute of each of the layers of media associated with the multiple beams that are triggered.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of operating a touchscreen device for playback of a multilayered media file, the method comprising:
displaying a plurality of triggers, each of the triggers is associated with a distinct layer of a plurality of layers of the multilayered media file;
receiving a touch gesture related to a touch on the touchscreen; and
controlling playback of the plurality of layers of media associated with the multilayered media file based on the touch gesture.

2. The method of claim 1, wherein each of one or more of the triggers is displayed as a beam.

3. The method of claim 1, further comprising:
triggering one or more of the triggers based on a position of the touch associated with the touch gesture.

4. The method of claim 1, further comprising:
controlling a first set of one or more attributes associated with a first layer of the plurality of layers based on a first direction of movement associated with the touch gesture; and
controlling a second set of the one or more attributes associated with the first layer of the plurality of layers based on a second direction of movement associated with the touch gesture, wherein the first direction is substantially orthogonal to the second direction and the first direction is substantially horizontal and the second direction is substantially vertical.

5. The method of claim 4, wherein the one or more attributes of the first layer include one or more of phase, frequency, amplitude, volume, pitch, tone, speed, and offset.

6. The method of claim 1, wherein the touch gesture is a first touch gesture, the method further comprising:
receiving a second touch gesture related to a second touch on the touchscreen; and
controlling an attribute of a layer of the plurality of layers based on the first touch gesture and the second touch gesture.

7. The method of claim 6, wherein the first touch gesture and the second touch gesture are received simultaneously and a plurality of attributes of the layer is controlled simultaneously based on the first touch gesture and the second touch gesture.

8. The method of claim 1, wherein:
the multilayered media file comprises a plurality of music programs,
each of the music programs comprises a subset of a predetermined musical composition, and
each of the music programs is correlated to each other.

9. The method of claim 8, wherein:
each of the musical programs comprises sound elements configured to generate sympathetic musical sounds.

10. The method of claim 8, wherein:
one of the triggers is associated with one of the musical programs.

11. An apparatus configured for playback of a multilayered media file, the apparatus comprising:
a touchscreen configured to receive a touch on the touchscreen; and
one or more processors configured to:
cause a display of the apparatus to display a plurality of triggers, each of the triggers is associated with a distinct layer of a plurality of layers of the multilayered media file;
receive a touch gesture related to the touch on the touchscreen, and
control playback of the plurality of layers of media associated with the multilayered media file based on the touch gesture.

12. The apparatus of claim 11, wherein each of one or more of the triggers is displayed as a beam.

13. The apparatus of claim 11, wherein the one or more processors are further configured to:
trigger one or more of the triggers based on a position of the touch associated with the touch gesture.

14. The apparatus of claim 11, wherein the one or more processors are further configured to:
control a first set of one or more attributes associated with a first layer of the plurality of layers based on a first direction of movement associated with the touch gesture; and
control a second set of the one or more attributes associated with the first layer of the plurality of layers based on a second direction of movement associated with the touch gesture, wherein the first direction is substantially orthogonal to the second direction and the first direction is substantially horizontal and the second direction is substantially vertical.

15. The apparatus of claim 14, wherein the one or more attributes of the first layer include one or more of phase, frequency, amplitude, volume, pitch, tone, speed, and offset.

16. The apparatus of claim 11, wherein:
the touch gesture is a first touch gesture,
the touch screen is further configured to receive a second touch on the touchscreen, and
the one or more processors are further configured to:
receive a second touch gesture related to a second touch on the touchscreen, and
control an attribute of a layer of the plurality of layers based on the first touch gesture and the second touch gesture.

17. The apparatus of claim 16, wherein the first touch gesture and the second touch gesture are received simultaneously and a plurality of attributes of the layer is controlled simultaneously based on the first touch gesture and the second touch gesture.

18. The apparatus of claim 11, wherein:
the multilayered media file comprises a plurality of music programs,
each of the music programs comprises a subset of a predetermined musical composition, and
each of the music programs is correlated to each other.

19. The apparatus of claim 18, wherein:
each of the musical programs comprises sound elements configured to generate sympathetic musical sounds.

20. The method of claim 18, wherein:
one of the triggers is associated with one of the musical programs.

21. A computer readable medium configured to store program instructions for playback of a multilayered media file, the program instructions configured to cause one or more processors to:
cause a display to display of a plurality of triggers, each of the triggers associated with a distinct layer of a plurality of layers of the multilayered media file;
receive a touch gesture related to a touch on a touchscreen, and
control playback of the plurality of layers of media associated with the multilayered media file based on the touch gesture.

22. The computer readable medium of claim 21, wherein each of one or more of the triggers is displayed as a beam.

23. The computer readable medium of claim 21, wherein the program instructions are further configured to cause the one or more processors to:
trigger one or more of the triggers based on a position of the touch associated with the touch gesture.

24. The computer readable medium of claim 21, wherein the program instructions are further configured to cause the one or more processors to:
control a first set of one or more attributes associated with a first layer of the plurality of layers based on a first direction of movement associated with the touch gesture; and
control a second set of the one or more attributes associated with the first layer of the plurality of layers based on a second direction of movement associated with the touch gesture, wherein the first direction is substantially orthogonal to the second direction and the first direction is substantially horizontal and the second direction is substantially vertical.

25. The computer readable medium of claim 24, wherein the one or more attributes of the first layer include one or more of phase, frequency, amplitude, volume, pitch, tone, speed, and offset.

26. The computer readable medium of claim 21, wherein the touch gesture is a first touch gesture and the program instructions are further configured to cause the one or more processors to:
receive a second touch gesture while receiving the first touch gesture, the second touch gesture related to a second touch on the touchscreen, and
control an attribute of a layer of the plurality of layers based on the first touch gesture and the second touch gesture.

27. The computer readable medium of claim 26, wherein the first touch gesture and the second touch gesture are received simultaneously and a plurality of attributes of the layer is controlled simultaneously based on the first touch gesture and the second touch gesture.

28. The computer readable medium of claim 21, wherein:
the multilayered media file comprises a plurality of music programs,
each of the music programs comprises a subset of a predetermined musical composition, and
each of the music programs is correlated to each other.
